(19) United States
(12) Patent Application Publication
(10) Pub. No.: US 2003/0055959 A1
(43) Pub. Date: Mar. 20, 2003

(54) Method and system for managing computer network and non-network activities

(76) Inventor: Kazuhiko Sato, Shinagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/190,309

(22) Filed: Jul. 3, 2002

(30) Foreign Application Priority Data
Aug. 27, 2001 (JP) 2001-256841

(51) Int. Cl. G06F 15/173

(52) U.S. Cl. 709/224

(57) ABSTRACT

A management system comprises a network and a managed area, wherein a managed device, located in a managed area, performs a predefined process outside the network. The managed device may be connected to the network, and is assigned or characterized by network information that allows the managed device to communicate over the network. The management system comprises a guard manager, adapted to monitor a status of the managed device relating to the predefined process, and an environment in the managed area. The management device further includes a management device connected to the network and the guard manager, which uses the network information of the managed device to manage a state of the managed device on the network, and manages the guard manager.

### BACKGROUND OF THE INVENTION

1. Field of the Invention

The invention relates generally to management systems for managing a computer network. More particularly, this invention relates to an integrated management system for a plurality of network devices connected to a computer network, such as a local area network (LAN) and wide area network (WAN).

2. Description of the Related Art

The present invention is suitable for an integrated management system, for example, of a production plant, which manages a network comprising a plurality of managed devices located in one or more managed areas (e.g., the entire plant or some rooms in the plant). The management system may additionally manage malfunctions of the managed devices, environmental conditions (including, for example, security, temperature, and humidity), and various types of equipment (such as an air-conditioning system, power supplies, lighting apparatuses) in the managed areas.

Along with the recent spread of LANs and WANs, a large number of network devices, such as personal computers (“PCs” hereinafter), hubs, switches, and routers (hubs etc. are often called “agents”) are being connected to networks and their subnet(s) for frequent information sharing and communications. For efficient management, a manufacturing plant, for example, may connect a plurality of manufacture machines, a host for controlling the manufacture machines, and a PC for use with a production manager, to a network and its subnets for information sharing and communication. Such a network environment typically uses a management device (also called “manager” or “server”) to monitor connection statuses and traffic for the centralized management, to locate malfunctions or failures in the network, as well as to assess risk management.

It is generally preferable to geographically locate a plant near cities which serve as destinations of the supplied products. However, the recently improved and extended traffic network has made it possible for a larger plant to be built in the suburbs or abroad for cheaper construction and labor costs while improving manufacturing ability.

Nevertheless, the increased number of managed devices in the larger scale plant would result in an increased burden on the management device and an insufficient network management system. In addition, integrated management, promoted between a headquarters and a large plant, preferably needs to enhance network security in integrating many departments within the plant. For example, a company may require high security management for access to some network devices for executives and the accounting department. In addition, distributed management for equipment (such as power supplies, lighting apparatuses, and air-conditioners), data, manufacture status, security, etc. in the plant would result in an increased management burden on an administrator of the plant.

### SUMMARY OF CERTAIN INVENTIVE EMBODIMENTS

The invention provides a management system for a network and a managed area, the management system comprising a managed device configured to perform a predefined process outside the network, wherein the managed device is located in the managed area, is connectable to the network, and is assigned network information that allows the managed device to communicate over the network. The management system further comprises a guard manager, configured to monitor a status of the managed device relating to the predefined process, and to monitor an environment in the managed area. The management system still further comprises a management device connected to the network and the guard manager, wherein the management device uses at least the network information of the managed device to manage a state of the managed device on the network, and wherein the management device manages the guard manager.

According to this management system, the management device provides network management based on the network information, and manages the guard manager so as to facilitate management of the managed area and the managed device with respect to the predefined process. Thus, the management device provides integrated management of the managed device with respect to both network and non-network activities, as well as to the environment in the area including the managed device. This integrated management lessens the burden on its administrator as compared to distributed management. The environment in the managed area may include temperature, humidity, luminous intensity, fire, gas leakage, air-condition, power, and an intrusion by an unauthorized person. The management device and the guard manager also constitute one aspect of the present invention.

The management system may further comprise an interconnecting device configured to connect the managed device and the management device to the network, wherein the network system includes a plurality of managed areas, managed devices, and guard managers, and wherein one or more managed devices and guard managers is located in each of the managed areas. The management device may configure the interconnecting device such that a different virtual local area network (VLAN) is assigned to each managed area based on the network information of the managed device located in that managed area. According to this management system, the management device configures the interconnecting device and logically divides the network based on the network information of the managed device, forming a plurality of groups which are not allowed to communicate with each other, even in the same network. Thereby, the management device may maintain the security for each VLAN group in the network.

The network information may include a communication parameter necessary for communications by the managed device in the network, e.g., an IP address, a subnet mask, a default gateway, a user ID and password, or a combination thereof, and device information that identifies the managed device, e.g., a MAC address and a housing identifier. The network information may also include a VLAN (i.e., an identifier of VLAN).

The managed device may control a specific machine to achieve execution of the predefined process, and the guard manager may monitor a state of the machine. Thereby, the management device may manage the machine via the guard manager. The managed device may have a storage part for storing data such as an operational state of the managed device, and the guard manager may receive specific data representative of the operational state of the managed device.

An additional aspect of the invention includes a method of managing a plurality of managed devices and a plurality of managed areas, wherein at least one managed device is located in each managed area, wherein the plurality of managed devices may be connected to a network and wherein at least one managed device is configured to perform a predefined process outside of the network. The method of managing a plurality of managed devices comprises assigning network information to the plurality of managed devices, wherein the network information allows the plurality of managed devices to communicate over the network, monitoring a status of the at least one managed device configured to perform a predefined process relating to the predefined process with a second device, managing a state of the managed device on the network with a third device, and managing the second device with the third device.

### BRIEF DESCRIPTION OF THE DRAWINGS

FIG. 1 is a block diagram of a management system according to one embodiment of the invention.

FIG. 2 is a block diagram of one embodiment of a network integrated with the management system of FIG. 1.

FIG. 3 is a block diagram of one embodiment of a management device used by the management system shown in FIG. 1.

FIG. 4 is a block diagram of one embodiment of an entrance server used by the management system shown in FIG. 1.

FIG. 5 is an exemplary management table created by the entrance server shown in FIG. 4.

FIG. 6 is a block diagram of one embodiment of an interconnecting device in the management system shown in FIG. 1.

FIG. 7 is a block diagram of one embodiment of a network device in the management system shown in FIG. 1.

FIG. 8 is a block diagram of one embodiment of a guard manager in the management system shown in FIG. 1.

FIG. 9 is a flowchart illustrating one embodiment of an initial setup operation of the management system shown in FIG. 1.

FIG. 10 is a flowchart illustrating creation of a management table in accordance with state 1000 of FIG. 9.

### DETAILED DESCRIPTION OF CERTAIN EMBODIMENTS

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

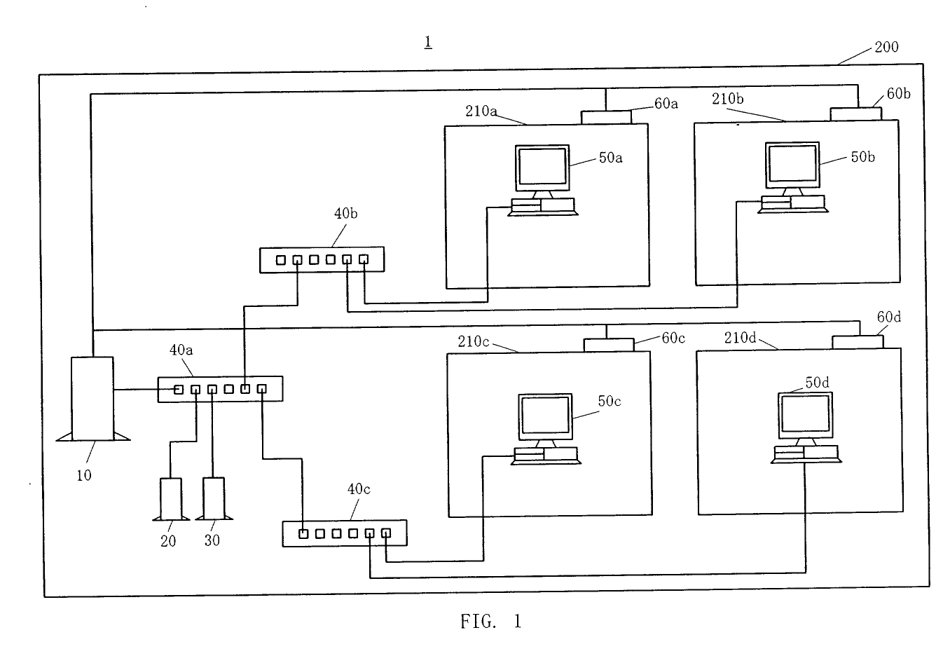

FIG. 1 is a block diagram of of a management system 1 according to one embodiment of the invention. As shown in FIG. 1, the management system 1 comprises a management device 10, an entrance server 30, a DHCP (Dynamic Host Configuration Protocol) server 30, a plurality of interconnecting devices 40, a plurality of network devices 50, and a plurality of guard managers 60. In this embodiment, the interconnecting devices 40, network devices 50, guard managers 60, and area 210 respectively generalize interconnecting devices 40a-40c, network devices 50a-50d, guard managers 60a-60d, and areas 210-210d, unless otherwise specified.

In one embodiment, the management system 1 is applied to a manufacturing plant 200 that uses machines to manufacture and process goods. The plant 200 includes a plurality of managed areas 210a-210d as independent spaces. The plant 200 has several interconnecting devices 40 to build the network 100 among these areas 210. Within these areas 210a-210d are the network devices 50a-50d which may be connected to the network 100 and used in these areas 210 as, for example, manufacture machines and controllers for controlling them.

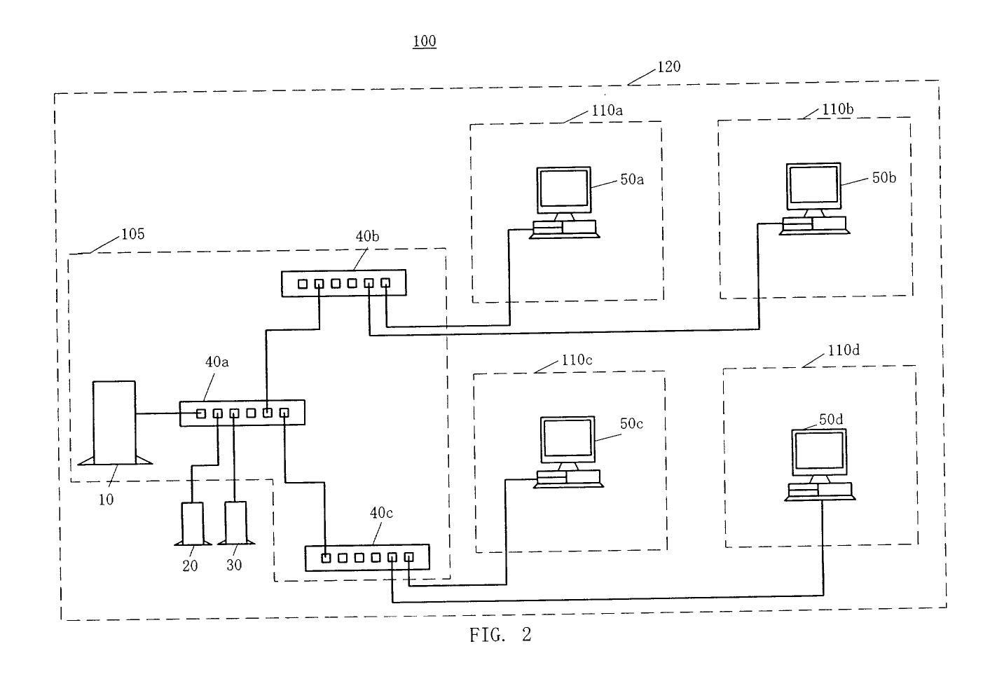

FIG. 2 is a block diagram of one embodiment of a network integrated with the management system of FIG. 1. The network 100 in the plant 200 is configured such that the network devices 50a and 50b are connected to the interconnecting device 40b, the network devices 50c and 50d are connected to the interconnecting device 40c, and the interconnecting devices 40b and 40c are connected to the interconnecting device 40a. Some network devices 50 may form a subnet (not shown) in the network 100 using a hub etc. The interconnecting device 40a is connected to the management device 10, entrance server 20, and DHCP server 30. A router may be connected to the interconnecting device 40 to access the Internet through the network 100. The management device 10, entrance server 20, and DHCP server 30 are provided, for example, in a management room for integrated management of the plant 200.

The guard managers 60a-60d are respectively provided for the areas 210a-210d, and configured to communicate with the management device 10. The guard manager 60 is provided close to or directly on a target to be monitored, and may be provided near a door at the entrance of the area 210, a floor, wall, or ceiling in the area 210, near or on the network device 50 or a device connected to the network device 50. The guard manager 60 may be connected to a lighting apparatus, air-conditioner, or power supply, which are not illustrated, in the area 210 and configured to communicate with them. Although the present embodiment uses a cable for connection between the guard manager 60 and the management device 10, any type of data communication means, including radio and wire communication, may be used.

It will be appreciated by one skilled in the technology that the structures shown in FIGS. 1 and 2 are for illustrative purposes, and the present invention is not limited to the number of areas 210, and the number of network devices 50 in each area 210.

The management device 10 manages the guard managers 60 as well as the network 100. More specifically, in one embodiment, the management device 10 configures the interconnecting devices 40 such that a different VLAN (Virtual Local Area Network) is assigned to each area 210 based on a device identifier of the network device 50. Moreover, the management device 10 may verify or authenticate information received from the guard manager 60, and manage the guard managers 60 in accordance with the information. The device identifier is related to network information, as will be described later.

In one embodiment, the management device 10 also manages a connection status and traffic of each network device 50 via the interconnecting device 40, although this management is not described in detail. For example, the network device 10 may obtain, from the interconnecting device 40, the communication amount and/or communication time for each communication port 42 of the interconnecting device 40. Based on the obtained communication amount and/or communication time, the management device 10 may control communications of the communication port 42 and create billing information.

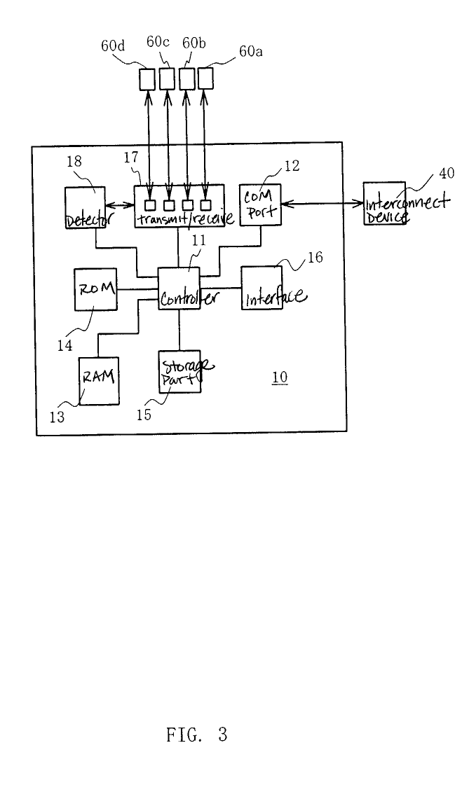

The management device 10 may be implemented as a desktop PC in one embodiment, however the management device may be any device capable of performing management functions as described. FIG. 3 is a block diagram of one embodiment of the management device 10. The management device 10 comprises a controller 11, a communication port 12, a RAM (Random Access Memory) 13, a ROM (Read Only Memory) 14, a storage part 15, an interface 16, a transmitter/receiver (transceiver) 17, and a detector 18. FIG. 3 does not show input/output devices (e.g., a keyboard, a mouse or other pointing devices, and an indication device, such as a display) provided with the management device 10. Through the input/output devices, an operator of the management device 10 may store various kinds of data in the storage part 15, and download software into the RAM 13, ROM 14 or storage part 15. As previously discussed, the management device 10 may be provided in the management room and used by an administrator of the plant 200. The administrator may use the management device 10 not only to manage the network 100, but also to comprehensively monitor and control the plant 200.

The controller 11 may be a processor, such as a central processing unit (CPU) or a microprocessor (MPU), and controls each module in the management device 10. The management device 10 may be connected to a host (not shown), and the controller 11 may communicate with the host.

The controller 11 receives network information from a management table created by the entrance server 20. It is desirable that such information include a MAC (Media Access Control) address. The controller 11 may store all or part of the network information in the storage part 15. The controller 11 may perform a predefined process or manage the guard manager 60 based upon information sent from the guard manager 60. The controller 11 may indicate the information sent from the guard manager 60 on the indication device (not shown).

In one embodiment, the controller 11 configures the interconnecting device 40 via the communication port 12 so as to assign a different VLAN to each area 210, based on a MAC address received from the entrance server 20 or stored in the storage part 15. Here, the VLAN (virtual LAN) may virtually group the network devices 50 irrespective of the physical network connections. The interconnecting device 40, in this embodiment, logically divides the network devices 50 into groups based on their MAC addresses, as will be described later. Alternately, it is possible to divide the network devices 50 into groups based on other types of network information, such as an IP (Internet Protocol) address and communication port 42 in the interconnecting device 40, but the MAC address may advantageously provide a higher level of security.

The controller 11 maintains security among the network devices 50 in the areas 210 using the VLAN technology in this embodiment. While the controller 11 configures the interconnecting device 40 so that a different VLAN is assigned to each area 210, it may configure the interconnecting device 40 such that the same VLAN is commonly assigned to some areas 210. The controller 11 may also use an arbitrary VLAN setup manner.

The communication port 12 may be an LAN adapter connected to the interconnecting devices 40, a USB (Universal Serial Bus) port or IEEE 1394 port for providing connections to the Internet (as necessary, via an Internet Service Provider (ISP)) via a modem, or a terminal adapter (TA) through the public telephone network, ISDN (Integrated Services Digital Network), or various types of dedicated lines. The RAM 13 may temporarily store data to be read from the ROM 14 and storage part 15, data to be written in the storage part 15, and the like. The ROM 14 may store various kinds of software and firmware for operations of the controller 11, and other types of software.

The storage part 15 stores a management program for managing the guard managers 60, and may store the MAC address or other types of network information which the controller 11 has received, as discussed above. The storage part may also store transmission history, including date, time, and a communication log.

The interface 16 may be, for example, a USB or a parallel port, and connects the management device 10 to an external device. The interface 16 may be an interface, irrespective of a type of data transmission method, such as parallel and serial systems, and a connection medium, such as radio and wire transmission. The management device 10 may use the interface 16 to connect to a Magneto-Optical (“MO”) drive, a floppy disc drive, or an integrated circuit (IC) card drive. Thereby, various applications may be stored i the storage part 15 and information in the network device 50 may be read from various media (such as a floppy disc, an MO disc, and an IC card).

The transceiver 17 connects the management device 10 to the guard managers 60 to establish communications between them. As shown in FIG. 3, the transceiver 17 includes ports corresponding to the number of guard managers 60 (or connected to the guard manager 60) and assign a port to each guard manager 60. A connection between the transceiver 17 and the guard manager 60 may use a serial cable, a parallel cable, etc., and the transceiver 17 may include a plurality of ports to be connected to these cables for each guard manager 60.

The detector 18 informs the controller that it has detected a signal sent from the guard manager 60 by communicating with each port in the transceiver 17. Thereby, the controller 11 specifies the port at which a signal is received and receives the signal. The detector 18 may use any structure known in the art, for example, which compares interconnecting device 42's port with a preset slice level, and thus a detailed description thereof is omitted.

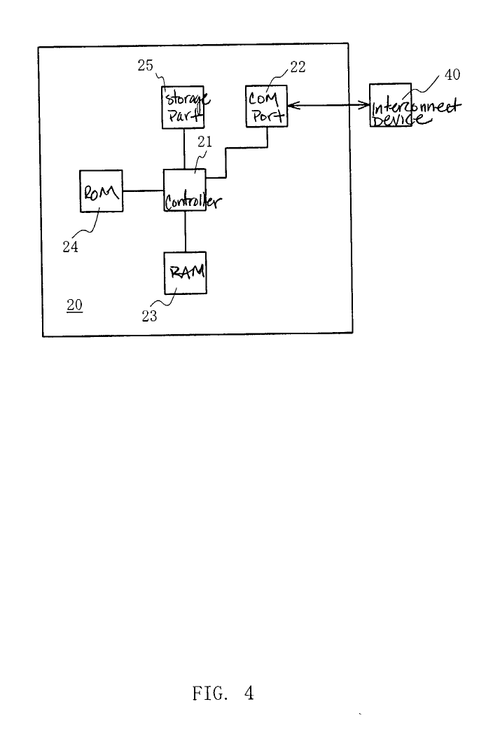

The entrance server 20 permits login to the network by the network device 50 having a predetermined MAC address. FIG. 4 is a block diagram of one embodiment of the entrance server 20. The entrance server 20 comprises a controller 21, a communication port 22, a RAM 23, a ROM 24, and a storage part 25.

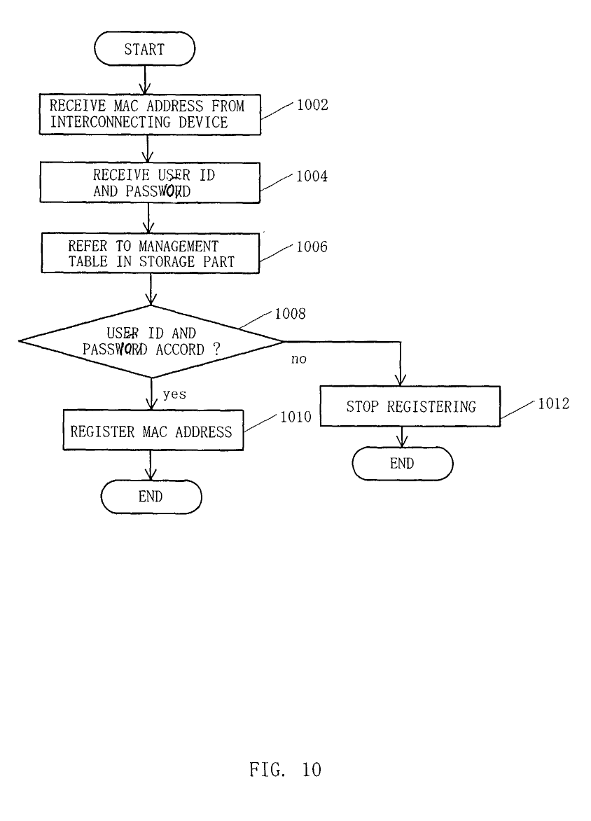

The controller 21 uses a program, such as the program illustrated in Figure 9, to build a management table as shown in FIG. 5. The controller 21 may refer to the management table, and permit the network device 50, having a predetermined MAC address, to login to the network 100.

The communication port 22 may be an LAN adapter connected to the interconnecting devices 40, a USB port or IEEE 1394 port for providing connections to the Internet (as necessary, via an Internet Service Provider (ISP)) via a modem, or a terminal adapter (TA) through the public telephone network, ISDN, or various types of dedicated lines.

The RAM 23 may temporarily store data to be read from the ROM 24 and storage part 25, data to be written in the storage part 25, and the like. The ROM 24 may store various kinds of software and firmware for operations of the controller 21, and other types of software.

The storage part 25 may store a management-table creating program, such as the program shown in FIG. 9, for creating the management table shown in FIG. 5. The management table in this embodiment stores, where four network devices 50 are connected to the network and its subnet(s), a relationship between the areas 210 and communication parameters and device information of the corresponding network device 50. The communication parameters and device information constitute network information for the network device 50 to communicate in the network. As described below, the network information includes the communication parameter used by the network device 50 to communicate over the network, e.g., an IP address, a subnet mask, a default gateway, a user ID an password, or a combination thereof, and device information that defines the network device 50, e.g., a MAC address and/or a housing identifier.

FIG. 5 is an exemplary management table. The management table stores, in order from the top, an identifier, a MAC address, an IP address, a user ID, and a password. An identifier of the VLAN may be included in the management table.

The identifiers 101, 102, 201 and 202, respectively identify four areas 210a-210d, are room numbers in plant 200's areas 210 in this embodiment, for example, 101 denotes a room no. 1 in a building no. 1, and 103 denotes a room no. 3 in a building no. 3. However, the identifiers may use any number and symbol, such as consecutive numerals (from l to n where n is a numeral corresponding to the number of the network devices 50) or non-consecutive arbitrary numerals so that the management device 10 may identify the areas 210 in the plant 200.

As is well known in the art, the MAC address is to identify an information device connected to a LAN.

The IP address is a period separated four-block address, each block ranging 0-255 in decimal notation, assigned to a computer connected to the TCP/IP (Transmission Control Protocol/Internet Protocol) network circumstance. The IP address is included in an IP header provided by the IP protocol in the network layer in the TCP/IP protocol.

The user ID and password are identifiers for identifying the user of the network device 50 who attempts to login to the network 100. The user ID and password are preferably determined offline, i.e., via telephone, facsimile, and/or mail, prior to a set up of communication parameters for the network device 50 by the user of the network device 50.

The communication parameters include an IP address assigned by the DHCP server 30, and a user ID and password in this embodiment, but may further include a subnet mask and a default gateway, or other parameters.

The subnet mask is a bit pattern for separating the host address part in the IP address into subnet and host addresses. When “255.255.255.0” is defined by the subnet mask, the first three numbers are represented in binary notation as ”11111111”. A “1” denotes the same network in the subnet mask. Therefore, four network devices 50 are connected to a network “192. 168. 1. 0”.

The default gateway is an IP gateway through which a host transmits an IP datagram, except when the host for transmitting the IP datagram incorporates a routing table including a destination IP address and when the destination IP address has the same network address as the transmitting host.

The communication parameters are not limited to the above, but may include a DNS (Domain Name System) address and a router address.

The typical device information of the network device 50 is an MAC address in this embodiment, but may include a housing identifier, and hardware and firmware versions. The housing identifier is an identifier for a housing of the network device 50. The hardware and firmware versions are, respectively, hardware and firmware versions for the network device 50.

The DHCP server 30 assigns communication parameters, e.g., the IP address, subnet mask, and default gateway, to a plurality of network devices 50. The DHCP server 30 may use any technology known in the art, and a description thereof is omitted.

The interconnecting device 40 connects the network device 50 to the network 100, and allows the management device 10 to execute the network management, i.e., management of the network devices 50 in the network. The interconnecting device 40 may be a switching hub, for example, but may be a switch, a router, any other concentrator, a PC, or a wireless interconnecting device (e.g., an access point as an interconnecting device for wireless LAN).

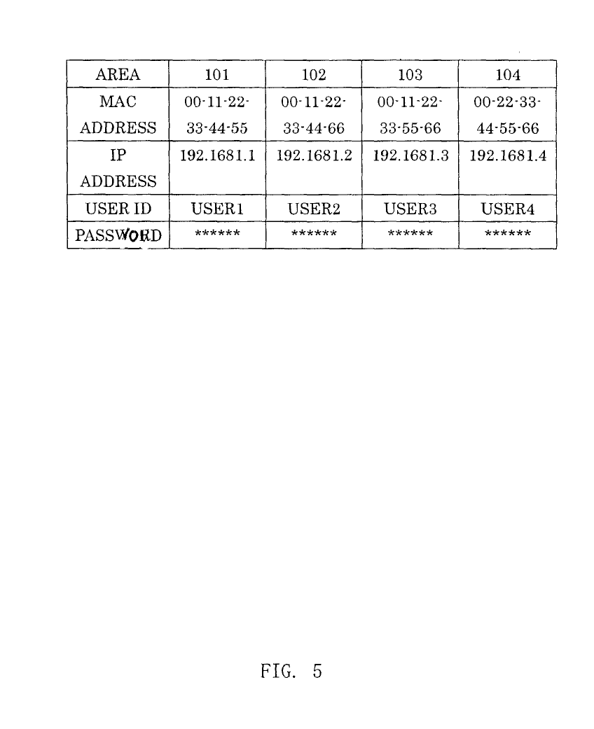

FIG. 6 is a block diagram of the interconnecting device 40. The interconnecting device 40 includes, as shown in FIG. 6, a controller 41, an interconnecting port 42, a RAM 43, a ROM 44, a storage part 45, a detector 46, and a communication port 47. FIG. 6 also omits the input/output devices, provided with the interconnecting device 40, for simplicity purposes.

The controller 41 may be a processor such as a CPU or an MPU, and may control each module in the interconnecting device 40. The controller 41 communicates with the detector 46, provides information for identifying the network device 50 to the entrance server 20, and manages the interconnecting ports 42 to logically divide the network 100 into each area 210 based on the MAC address of the network device 50 to be connected to the interconnecting device 40.

The interconnecting port 42 is a communication port configured for connection to the network devices 50 by a cable or the like. In one embodiment, the interconnecting devices 40b and 40c are connected to the interconnecting ports 42 in the interconnecting device 40a. The network devices 50a and 50b are connected to the interconnecting ports 42 in the interconnecting device 40b, while the network devices 50c and 50d are connected to the interconnecting ports 42 in the interconnecting device 40c.

The RAM 43 may temporarily store data to be read from the ROM 44 and storage part 45, data to be written in the storage part 45, and the like. The ROM 44 may store various kinds of software and firmware for operations of the controller 41, and other types of software. The storage part 45 may store a program for managing the interconnecting ports 42. Such a program may use any technology known in the art, and a detailed description thereof is omitted.

The detector 46 detects power-on of the network device 50 by communicating with the interconnecting port 42, and notifies the controller 41 of the detection result. Since the detector 46 uses any structure known in the art, for example, comparison of the voltage of the interconnecting port 42 with a specific slice level for detection purposes, a detailed description of the detector 46 is omitted.

The communication port 47 may be an LAN adapter, a USB port or IEEE 1394 port for providing connections to the Internet (as necessary, via an Internet Service Provider (ISP)) via a modem, or a terminal adapter (TA) through the public telephone network, ISDN, or various types of dedicated lines. The interconnecting device 40 communicates with the management device 10 through the communication port 47.

The network device 50 is managed by the management device 10, and may be implemented as a machine, including a manufacture machine and a controller for controlling the manufacture machine, or as an information processor used for the plant 200. The network device 50 may be a network device, such as a hub, a switch, a router, any other concentrator, a repeater, a bridge, a gateway device, a PC, a server, a wireless interconnecting device (e.g., an access point as a interconnecting device for wireless LAN), or a game machine having a communication function.

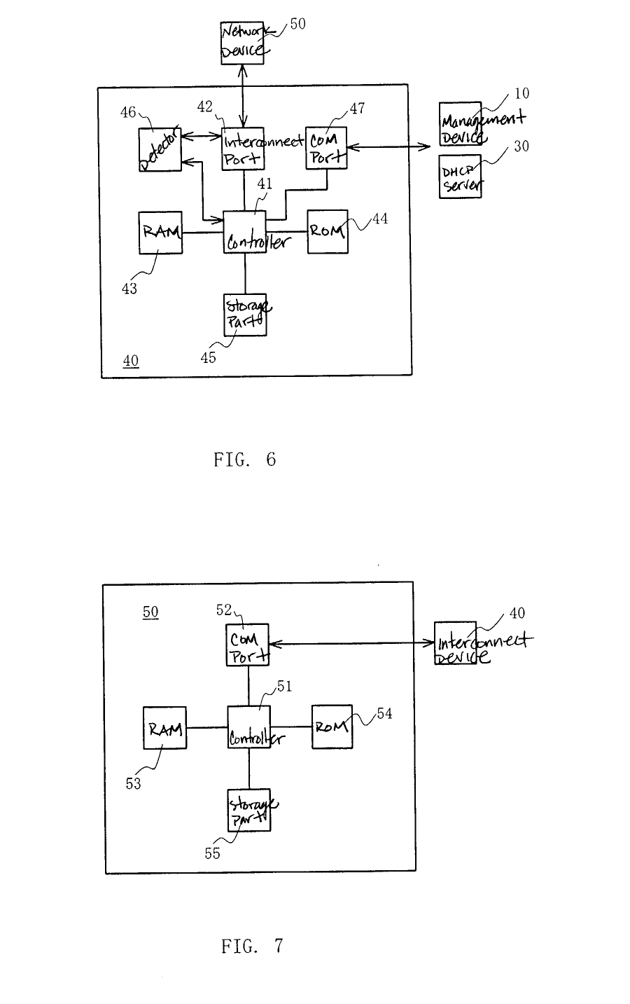

FIG. 7 is a block diagram of the network device 50. The network device 50 comprises a controller 51, a communication port 52, a RAM 53, a ROM 54, a storage part 55, and a transceiver 56. FIG. 7 also omits the input/output devices, provided with the network device 50, for simplicity purposes. Through the input device, an operator of the network device 50 may input various kinds of data in the storage part 55, and download software into the RAM 53, ROM 54, and storage part 55. The network device 50 may be connected to a host (not shown) and communicate with the host. For example, the network device 50 may be connected to the manufacture machine used for the plant 20 and may control the manufacture machine.

The controller 51 may be a processor such as a CPU or an MPU, and may control each module in the network device 50. When the guard manager 60 is connected as described later, the controller 51 may transmit data (such as data to be stored in the storage part 55 and information to be indicated on an indication device) to the guard manager 60 via an interface (not shown).

The communication port 52 may be an LAN adapter for establishing a connection to the network, a USB port or IEEE 1394 port for providing connection to the Internet (as necessary, via an Internet Service Provider (ISP)) via a modem, or a terminal adapter (TA) through the public telephone network, ISDN, or various types of dedicated lines. The communication port 52 is an interface to be connected to the interconnecting port 42 in the interconnecting device 40 in this embodiment.

The RAM 53 may temporarily store data to be read from the ROM 54 and storage part 55, data to be written in the storage part 55, and the like. The ROM 54 may store various kinds of software and firmware for operations of the controller 51, and other types of software. The storage part 55 may store a communication parameter and a configuration program, wherein the configuration program is a program to receive communication parameters from the DHCP server 30 and to configure them.

Each guard manager 60 may guard the network devices 50 and the areas 210 including the network devices 50. More specifically, the guard manager 60 receives desired data from the network device 50, and monitors and controls the areas 210, as described later. For example, the guard manager 60 is connected to the network device 50, and receives information to be displayed on the indication device or to be stored in the storage part 55 in the network device 50. The guard manager 60 monitors an environment in the area 210, including room temperature, a lighting status (e.g., how many lighting apparatuses are turning on, which lighting apparatus is turning off, how much luminous intensity it has, etc.), a power status (e.g., how many power supplies are activated, which power supply is turned off, etc.), and an air-conditioning status (e.g., what temperature has been set, how many air-conditioners are provided, which air-conditioner is not working, etc.). The guard manager 60 may combine these functions, or include any additional function to govern the network device 50 and areas 210 including the network devices 50.

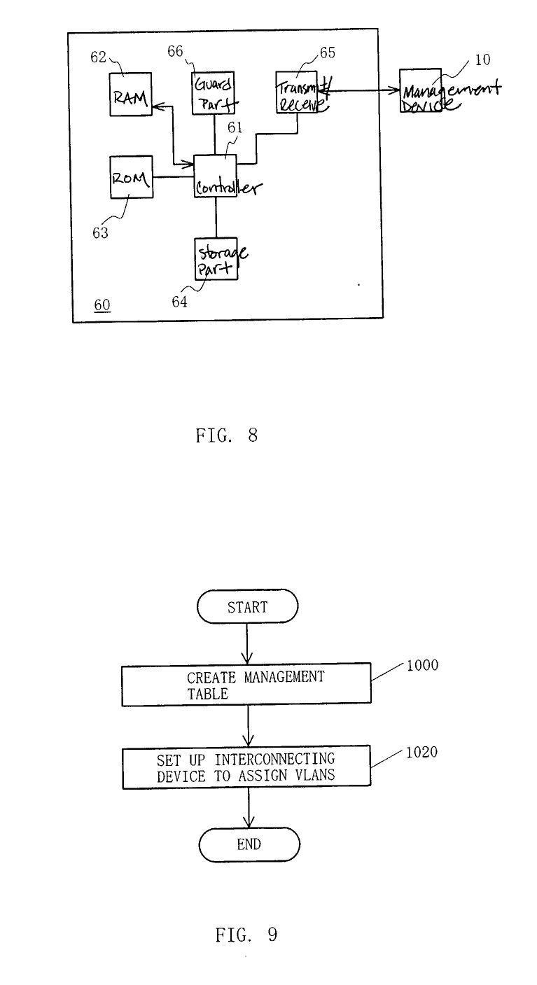

FIG. 8 is a block diagram of the guard manager 60. The guard manager 60 includes, as shown in FIG. 8, a controller 61, a RAM 62, a ROM 63, a storage part 64, a transceiver 65, and a guard part 66. In this embodiment, the guard part 66 comprehensively includes an interface which is connected to the network device 50 and allows the guard manager 60 to communicate with the network device 50, an image recording device for monitoring a state in the area 210, and an infrared or any other sensor for guarding the area 210 against an intrusion, a temperature sensor for monitoring the (room) temperature in the area 210, and a humidity sensor for monitoring the humidity in the area 210. The guard part 66 may further include a control part for controlling the air-conditioners, power supplies, and lighting apparatuses in the areas 210.

The controller 61 may be a processor such as a CPU or an MPU, and may control each module in the guard manager 60. The controller 61 may send a request to the network device 50 for data for guard purposes via the guard part 66, and receive the data, wherein the guard part 66 serves as the interface. The control part 61 may control the guard part 66, wherein the guard part 66 serves as the image recording device and the control part for the lighting apparatuses, power supplies, and air-conditioners. The controller 61 may detect an intrusion and temperature variance in accordance with a signal from the guard part 66, wherein the guard part 66 serves as the infrared sensor, temperature sensor etc. The infrared sensor may generate a predefined signal when detecting an intruder. The temperature sensor may generate a predefined signal when detecting the temperature is above or below a specific temperature or set of temperatures. The controller 61 sends data received from the network device 50 to the management device 10, including data recorded by the image recording device, signals from the sensors, and statuses of lighting apparatuses, power supplies, and air-conditioners.

The RAM 62 may temporarily store data to be read from the ROM 63 and storage part 64, data to be written in the storage part 64, and the like. The ROM 63 may store various kinds of software and firmware for operations of the controller 61, and other types of software. The storage part 64 may store all or part of the data received from the network devices 50.

The transceiver 65 sends information to the management device 10 or receives information from the management device 10. The transceiver 65 is similar to the transceiver 17 in the management device 10, and a detailed description is therefore omitted.

Management of the network 100 by the management device 10 will now be described with reference to FIGS. 9 and 10. FIG. 9 is a flowchart illustrating an initial set up operation for the network 100 in the management system 1. FIG. 10 is a flowchart illustrating state 1000 of the flowchart of FIG. 9 in more detail. Since the management device 10 does not know the device information (or a MAC address) of the network device 50 upon initial startup, the management device 10 needs to advantageously obtain this information in the initial operation.

It is desirable to provide the entrance server 20 with the device information, and thus create the management table for managing the network devices 50 in a state 1000. Referring now to FIG. 10, in a first state, the network device 50 is powered on and connected to the network 100. Then, the detector 46 in the interconnecting device 40 detects the power on of the network device 50, and the controller 41 in the interconnecting device 40 specifies the communication port 42. The controller 21, in the entrance server 20, receives notification from the interconnecting device 40 that the network device 50 connected to the interconnecting device 40 is powered on. Next, in a state 1002, the controller 21 in the entrance server 20 receives the MAC address of the network device 50 connected to the interconnecting device 40 from the interconnecting device 40. Then, in a state 1004, the controller 21 receives a user ID and password from the network device 50 that has attempted to login to the network 100. In a state 1006, the controller 21 refers to the management table in the storage part 25, and determines whether the received user ID and password correspond to those stored in the management table in a state 1008. If no authentication is reached in state 1008, then the controller 21 stops the registration of the MAC address in a state 1012. If an authentication has been reached, the controller allows a registration of the received MAC address in the management table in a state 1010. The entrance server 20 may simultaneously allow the DHCP server 30 to configure the communication parameters, including the IP address.

The entrance server 20 then transmits the desired network information for the management table to the controller 11 in the management device 10. The desired network information may include, as discussed above, the identifier of the area 210, MAC address, IP address, user ID and password, but the MAC address is sufficient in this embodiment. Referring back to FIG. 9, the controller 11 (or administrator) for the management device 10 configures the interconnecting devices 40 in a state 1020 such that a different VLAN is assigned to each area 210 based on the MAC address stored in the management table.

In one embodiment, the controller 11 (or administrator) assigns the same VLAN 105 as that of the management device 10 to the interconnecting devices 40. Therefore, the management device 10 may control the interconnecting devices 40 in the VLAN 105, and perform a VLAN configuration for the interconnecting devices 40. The controller 11 (or administrator) may assign VLANs 110a-110d, different from the VLAN 105, to the network devices 50 in the multiple areas 210. Thereby, the management device 10 cannot access files in the network device 50 in each area 210. Conversely, the network devices 50 may neither access files in the management device 10, nor perform a VLAN configuration for the interconnecting devices 40. The network device 50 in one area 210 (e.g., the area 210a) cannot access files in the network device 50 of another area 210 (e.g., the area 210d). The controller 11 may assign a VLAN 120 to the entrance and DHCP servers 20 and 30. The VLAN 120 allows the entrance and DHCP servers 20 and 30 to communicate with the VLANs 105 and 110a-110d.

Thus, VLAN technology may be used to maintain securities among network devices 50 in the areas 210, thereby providing high levels of security in the plant 200. Although the described embodiment assigned a VLAN for each area 210, the same VLAN is commonly assigned to multiple areas 210. When multiple network devices 50 are located in the same area 210, a different VLAN may be assigned to one or more of these network devices 50 in this area 210. Thus, any VLAN structure is applicable to the present invention, and not limited to the structure in this embodiment.

In management of the network 100, an operator of the network device 50 powers on the network device 50 attempting to establish communication with the network 100. The detector 46 in the interconnecting device 40 detects the power on of the network device 50, and the controller 41 in the interconnecting device 40 specifies the communication port 42 to which the network device 50 is connected. The controller 21 in the entrance server 20 receives, from the interconnecting device 40, notification that the network device 50 connected to the interconnecting device 40 is powered on. Next, the controller 21 in the entrance server 20 receives, from the interconnecting device 40, the MAC address of the network device 50 connected to the interconnecting device 40. Then, the controller 21 refers to the management table in the storage part 25, and determines whether the received user ID and password correspond to those stored in the management table.

In the event the received MAC address has already been stored in the management table, the entrance server 20's controller 21 allows the DHCP server 30 to assign the communication parameters, including the IP address, to the network device 50 using the received MAC address. Then, the controller 21 records the communication parameters, including the IP address, in the management table, and allows the interconnecting device 40 to communicate using its interconnecting port 42 connected to the network device 50, with the received MAC address. Thereby, the network device 50 may access the network 100, and, for example, the Internet through a router, and share files and a printer among other network devices in the same VLAN using a common server connected to the network 100. As described above, the management device 10 may manage structure, performance, security, and billing of the network 100 by managing connection and traffic statuses of the network device 50 via the interconnecting device 40.

When the received MAC address has not yet been stored in the management table, the entrance server 20's controller 21 prohibits the DHCP server 30 from assigning the communication parameters, including the IP address, to the network device 50 with the received MAC address. The controller 21 also prohibits the interconnecting device 40 from communicating using its interconnecting port 42, connected to the network device 50, with the received MAC address. The controller 21 may notify an administrator through the management device 10 of the unauthorized attempted access to the network 100.

The entrance server 20, may thus permit the network device 50 with the predetermined MAC address to access the network 100, and prohibit an unauthorized network device from accessing the network 100. The user ID and password are used in the initial setup, and need not, but may be entered whenever the user attempts to access the network 100. Although the conventional authentication system employing a user ID and password may unintentionally give an intruder an opportunity of a spoof, the described management system easily eliminates such an intruder because he cannot easily obtain neither the MAC address of the network device 50 nor the knowledge that the MAC address is used for authentication. In addition, since the interconnecting device 40 is connected so that each area 210 has a different VLAN, the security for each network device 50 may be maintained in the network 100.

A description will now be given of the management of the network devices 50, and areas 210 where the network devices 50 are located, in the management system 1. As described above, the network device 50 may be connected to or disconnected from the network 100 arbitrarily. The administrator uses the management device 10 to manage the network devices 50 with respect to their off-network activities, and the areas 210 including the network devices 50 as follows:

Suppose that the guard part 66 in the guard manager 60 serves as an interface for connection between the network device 50 and the guard manager 60, as described above. The network device 50 may advantageously include a corresponding interface (not shown) so as to transmit data to and receive data from the guard manager 60.

Then, management device 10's controller 11 requests information (e.g., a drive state of the current network device 50) from the guard manager 60, which is to be displayed on the indication device (not shown) in the network device 50. In response, the controller 61 in the guard manager 60 obtains desired information from the network device 50 (or requests the information from the network device 50 and receives the information from the network device 50). Then, the controller 61 sends the information to the management device 10. Thereby, the detector 18 in the management device 10 specifies the port by a method such as detecting a current level larger than a predefined current level in the port of the transceiver 17, and designates the port to the controller 11. The controller 11 receives the information and indicates it on the indication device (not shown), so that the administrator of the management device 10 may monitor the state of the network device 50, for example, the state of the manufacture machine which an operator of the manufacture machine may see in the plant 200.

The administrator may confirm a faulty state and an operational state of the network device 50 based on the indication device. When the administrator discovers a faulty state, he/she may inform network device 50's operator of the faulty state in the area 210 using, for example, a telephone or any other telecommunication device. The guard manager 60 may include an alarm, and the management device 10 may drive the alarm. Transmissions from a plurality of guard managers 60 may provide integrated management of the multiple network devices 50. For example, the management device 10 may include a plurality of displays, or one display screen divided into multiple sections, to indicate multiple pieces of information related to the plurality of network devices 50. The management device 10 may include a switch that switches among a plurality of ports so as to selectively indicate these plural pieces of information on the indication device.

The management device 10's controller 11 may request data from the guard manager 60, representative of off-network activities, i.e., working state of the network device 50, such as a history of drives which represents a past record of operational states of the network device 50 generated whenever it is driven, and current configurations of the network device 50 and any associative machine, such as a manufacture machine (including the manufacture ability per time). The drive history may also include information on driving time periods, drive dates, and production efficiencies corresponding to the driving time periods.

The controller 11 requests data regarding the network device 50 from the guard manager 60. In response, the controller 61 in the guard manager 60 obtains the desired data from the network device 50 (or requests the information from the network device 50 and receives the information from the network device 50). The controller 61 then transmits the information to the management device 10. Thereby, the detector 18 in the management device 10 specifies the port by detecting a current larger than the predefined current in the port in the transceiver 17, and designates the port to the controller 11. The controller 11 receives the information and displays it on the indication device (not shown) or stores it in the storage part 15, so that the administrator of the management device 10 may monitor the state of the network device 50 from the location of the management device 10. Transmissions from a plurality of guard managers 60 provide integrated management of the multiple network devices 50.

Next, suppose that the guard part 66 in the guard manager 60 is implemented as an infrared sensor or a temperature sensor, as described above. For example, the infrared sensor comprises an infrared light emitting element for emitting infrared rays, and an infrared light detecting element configured to output an electric signal corresponding to the strength of the infrared rays detected. The temperature sensor may use a known structure, as typified by a thermostat, which generates a signal above or below a predefined temperature or set of temperatures. The infrared sensor may be provided, for example, such that the light emitting and detecting elements are provided at the entrance to the area 210 such that the infrared ray or beam crosses an entry route. The temperature sensor may be provided on the ceiling in the area 210, for example. The infrared sensor is not limited to the described location, and may be positioned so as to serve the function of detecting intruders. Also, the temperature sensor may be provided on a wall, and is not limited to a ceiling location.

In such a structure, the controller 11 in the management device 10 sends a command to the guard manager 60 to detect the presence of the signal from the above described sensor(s). In response, the controller 61 in the guard manager 60 awaits a signal from the sensor. When an object crosses the entry route, the light received at the detecting element is interrupted, and in response its output becomes weaker or stronger. The controller 61 may detect the stronger or weaker signal by detecting the output from the light detecting element using a specific threshold. Alternately, when the room temperature in the area 210 reaches a level above or below the predefined value, the temperature sensor generates a predefined signal. The controller 61 informs the controller 11 in the management device 10 that the sensor has responded in such a way.

Thereby, the detector 18 in the management device 10 specifies the port by detecting the current larger than the predefined current in the port in the transceiver 17, and notifies the controller 11 of the port at which the larger current is detected. The controller 11 receives the information and indicates an error message with an identifier of the area 210 corresponding to the port in the transceiver 17. Thereby, the administrator of the management device 10 may monitor the abnormal state in the area 210 from the location of the management device 10. The above configuration enables the operator to identify and locate an unauthorized person entering the area 210 and abnormal temperature rise or fall in the area 210. It may be advantageous to monitor a person who enters the area 210 to maintain the security. The temperature management in the area 210 is also advantageous, for example, where the area 210 requires specific temperature maintenance for food products.

When the administrator confirms the abnormality indicated by the sensors, he may inform the operator of the network device 50 of the faulty state in the area 210 using, for example, a telephone or other communication device. The guard manager 60 may include an alarm, and the management device 10 may control the operation of the alarm. Communication with a plurality of guard managers 60 may thus provide integrated management of the multiple network devices 50.

The present invention may use any sensor for detecting an abnormal state in the area 210, such as humidity, luminous intensity, fire, gas leak, etc.

Next, suppose that the guard part 66 in the guard manager 60 is implemented as a control part for image recording device(s), lighting apparatuses, power supplies, and air-conditioners, as described above. In this embodiment, the guard part 66 as the control part in the guard manager 60 is adapted to communicate with controllers in each of the image recording device(s), lighting apparatuses, power supplies, and air-conditioners. Alternatively, the controller 11 in the management device 10 directly controls these devices. The controller 11 in the management device 10 instructs the guard manager 60 to power on the image recording device(s), lighting apparatuses, power supplies, and air-conditioners. In response, the guard part 66, as the control part in the guard manager 60, communicates with the controllers in these devices and instructs the controllers to power on the devices. Then, the controllers drive the devices.

When the image recording device is driven, the controller 61 receives information sent from the image recording device and sends the information to the management device 10. The operator of the management device 10 may confirm the transmitted information on the indication device (not shown) by a procedure similar to the procedure described above. For example, the operator of the management device 10 may confirm an image from the image recording device, and monitor an unauthorized person entering the area 210 and the drive state of the network device 50 (e.g., a state of the manufacture line).

In driving the lighting apparatuses, power supplies, and air-conditioners in all or parts of areas 210, the management device 10 does not have to drive all of these devices. For example, the management device 10 selects the area 210 to be used, and controls the guard manager 60 in that area 210. The management device 10 may indicate states of these devices on the indication device (not shown). In this state, the controller 11 communicates with the controllers in the lighting apparatuses, power supplies, and air-conditioners, or the guard part 66 as the control part in the guard manager 60, so as to configure the area 210 for the desired luminous intensity and the desired temperature.

The controller 11 in the management device 10 may instruct the guard manager 60 to power off the image recording device(s), lighting apparatuses, power supplies, and air-conditioners. In response, the guard part 66 in the guard manager 60 communicates with the controllers in these devices and may send a power-off instruction to the controllers, whereby the controllers in these devices stop driving the image recording device(s), lighting apparatuses, power supplies, and air-conditioners. The management device 10 may indicate the inactivated state for each area 210 on the indication device (not shown).

Such a structure provides the administrator of the management device 10 with integrated management of the image recording device(s), lighting apparatuses, power supplies, and air-conditioners in the plant 200 by only operating the management device 10. The management device 10 may prevent unintentional powering off of the power supplies, lighting apparatuses, and air-conditioners, and contribute to power conservation.

As described above, according to the management system 1, the management device 10 provides integrated management of the network devices 50 on the network 100, the off-network activities of the network devices 50, and areas 210 including the network devices 50. The management system 1 may assign a different VLAN to each area 210 based on the MAC addresses of the network device 50, maintaining high security for the network 100. In addition, the management device 10 may provide integrated management of states and environments in the plant 200, which may be more efficient than a distributed management, and may lessen the management burden on the administrator. The management system, when applied to the manufacturing plant, provides the network with high security and management efficiency, and may thus enhance the value of the plant.

Further, the present invention is not limited to the preferred embodiment, and a number of variations and modifications may be made without departing from the present invention. The management system of the present invention is applicable, for example, to an office building, school, etc.

According to the management system, the management device for managing the network manages not only the network based on the network information of the network devices, but also the guard manager that manages the network devices and areas including the network devices in the plant. Thereby, the network device provides integrated management of the network and plant including a plurality of network devices in various areas.

The foregoing description details certain embodiments of the invention. It will be appreciated, however, that no matter how detailed the foregoing appears in text, the invention may be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A management system comprising:
a managed device, located in a managed area, and configured to perform a predefined process outside a network, wherein the managed device is characterized by network information that allows the managed device to communicate over the network;
a guard manager configured to monitor status of the managed device relating to the predefined process, and to monitor an environment in the managed area; and
a management device that is electrically connected to the network and the guard manager, wherein the management device is configured to manage a state of the managed device on the network based on at least the network information of the managed device, and is further configured to manage the guard manager.

2. The management system of claim 1, further comprising a plurality of managed areas, a plurality of managed devices, a plurality of guard managers, and at least one interconnecting device, wherein the interconnecting device connects the managed devices and the management devices to the network, wherein at least one of the plurality of managed devices and at least one of the plurality of guard managers are located in each managed area, and wherein at least one interconnecting device is configured such that a distinct virtual local area network (VLAN) is assigned to each managed area based on the network information of the managed device.

3. The management system of claim 1, wherein the network information comprises a media access control (MAC) address of the managed device, and the network comprises a computer network.

4. The management system of claim 1, wherein the network information comprises an internet protocol (IP) address of the managed device, and the network comprises a computer network.

5. The management system of claim 1, wherein the network information comprises a communication parameter necessary for the managed device to communicate over the network and device information that identifies the managed device.

6. The management system of claim 1, wherein the managed device controls a specific machine so as to execute the predefined process, and wherein the guard manager monitors a state of the machine via the managed device.

7. The management system of claim 1, wherein the environment in the managed area is characterized by a plurality of environmental parameters representative of at least one of temperature, humidity, lighting state, fire state, gas leakage state, an air-condition status, a power status, and a state of intrusion by an unauthorized person.

8. The management system of claim 1, wherein the managed device stores data including an operational state of the managed device, and wherein the guard manager receives specific data representative of the operational state of the managed device.

9. The management system of claim 8, wherein the specific data received by the guard manager includes a history of drives representing a past record of operational states of the managed device generated when the managed device is driven, and a current configuration in the managed device.

10. A management device connected to a network for managing a managed device located in a managed area, wherein the managed device is configured to perform a predefined process outside the network, and wherein the managed device is characterized by network information allowing the managed device to communicate over the network, the management device comprising:
a first communication portion connected to an interconnecting device, wherein the interconnecting device connects the management device and the managed device to the network;
a second communication portion connected to a guard manager, wherein the guard manager is connected to the management device and configured to monitor a status of the managed device relating to the predefined process, and to monitor an environment in the managed area; and
a controller that is electrically connected to and configured to control the managed device in the network based on at least the network information and the interconnecting device, wherein the controller is configured to manage the guard manager based on at least information received from the guard manager.

11. The management device of claim 10, wherein the controller is further configured to control a connection status and communication traffic of the managed device in the network.

12. A guard manager, connected to a management device that is connected to a network, wherein the network is configured to connect to a managed device located in a managed area, wherein the managed device performs a predefined process outside the network and is characterized by network information that allows the managed device to communicate over the network, wherein the management device uses at least the network information to manage a status of the managed device on the network, and wherein the management device is configured to manage the guard manager, the guard manager comprising:
a guard part, configured to monitor status of the managed device relating to the predefined process and an environment in the managed area; and
a controller, configured to notify the management device of an abnormal state, if any, detected by the guard part.

13. A method of managing a plurality of managed devices and a plurality of managed areas, wherein at least one managed device is located in each managed area, wherein the plurality of managed devices are configured to connect to a network, and wherein at least one managed device is configured to perform a predefined process outside of the network, the method comprising:
assigning network information to the plurality of managed devices, wherein the network information allows the plurality of managed devices to communicate over the network;
monitoring status of the managed devices relating to the predefined process with a second device;
managing a state of the managed device on the network with a third device; and
managing the second device with the third device.

14. The method of claim 13, wherein the network information is a media access control (MAC) address.

15. The method of claim 13, further comprising controlling a machine with the managed device to achieve execution of the predefined process, and monitoring a state of the specific machine via the managed device.

16. The method of claim 13, further comprising receiving by the second device data representative of an operational state of the managed device.

17. The method of claim 13, further comprising monitoring an environment in at least one of the managed areas, wherein the environment in the managed area is characterized by a plurality of parameters representative of at least one of temperature, humidity, a lighting state, fire state, gas leakage state, an air condition status, a power status, and a state of intrusion by an unauthorized person.

18. The method of claim 17, wherein monitoring a status of the managed devices is performed by the third device.

19. A system for managing a plurality of managed devices and a plurality of managed areas, wherein at least one managed device is located in each managed area, wherein the plurality of managed devices are configured to connect to a network, and wherein at least one managed device is configured to perform a predefined process outside of the network, the system comprising:
means for assigning network information to the plurality of managed devices, wherein the network information allows the managed devices to communicate over the network;
means for monitoring a status of the at least one managed device configured to perform a predefined process, wherein the status relates to the predefined process; and
means for managing a state of the managed device on the network, and for managing the means for monitoring a status of the at least one managed device configured to perform a predefined process.

20. The system of claim 19, wherein the means for managing a state of the managed device is configured to monitor an environment in the managed area, wherein the environment is characterized by a plurality of parameters representative of at least one state of temperature, humidity, lighting, fire, gas leakage, air conditioning, power, and intrusion by an unauthorized person.

21. The system of claim 19, wherein the managed device controls a machine to achieve execution of the predefined process, and wherein the means for monitoring a status of the managed device monitors a state of the machine via the managed device.
